(19) United States
(12) Patent Application Publication
(10) Pub. No.: US 2025/0074151 A1
(43) Pub. Date: Mar. 6, 2025

(54) HEATING DEVICE

(71) Applicants: HYUNDAI MOTOR COMPANY, SEOUL (KR); KIA CORPORATION, SEOUL (KR); HANON SYSTEMS, DAEJEON (KR)

(72) Inventors: Gyeong Nam Cho, Daegu (KR); Su Yeon Kang, Seoul (KR); Myung Hoe Kim, Seoul (KR); Dong Won Yeon, Hwaseong-si (KR); Dong Hoon Oh, Daejeon (KR); Sae Dong Eom, Daejeon (KR); Yun Hwan Yang, Daejeon (KR)

(21) Appl. No.: 18/602,625

(22) Filed: Mar. 12, 2024

(30) Foreign Application Priority Data
Aug. 28, 2023 (KR) 10-2023-0113049

(51) Int. Cl. B60H 1/22

(52) U.S. Cl. CPC B60H 1/2225

(57) ABSTRACT

A heating device provides heat for heating in various modes, such as an air flow direction control mode, a radiant heat specialized mode, and a convective heat specialized mode, through rotation of thermally conductive plates depending on user's requirements, thereby increasing user satisfaction. The thermally conductive plates increase heating efficiency by ensuring thermal efficiency according to a mode corresponding to the purpose of use.

### CROSS REFERENCE TO RELATED APPLICATIONS

This application claims the priority benefit of Korean Patent Application No. 10-2023-0113049, filed on Aug. 28, 2023 in the Korean Intellectual Property Office, the disclosure of which is incorporated herein by reference.

### BACKGROUND

### 1. Field of the Disclosure

The present disclosure relates to a heating device configured to provide heated air.

### 2. Description of the Related Art

A heater is a device that generates heat through heat-generating operation, and is widely used for various systems, such as a hot air blower for providing hot air or an air-conditioning system for mobility vehicles. Such a heater may be implemented as a positive temperature coefficient (PTC) heater, which is adjusted in heating value by controlling the amount of current applied based on a PWM duty ratio.

In the case of hybrid vehicles or electric vehicles, a heater using electricity is mainly used because of insufficiency or absence of engine coolant required for heating.

Recently, a heater has been applied to a side of a grill from which air is discharged. However, such a heater has a fixed configuration that heats air without a separate air flow direction control function.

In addition, in order to improve heat dissipation efficiency thereof, the heater is configured such that heat dissipation plates are disposed so as to be misaligned from each other. However, this configuration causes resistance to the flow of air. In addition, it is not possible to selectively provide radiant heat using the heater, and a portion of thermal energy is always used as radiant heat, leading to deterioration in convective heat transfer efficiency.

The information disclosed in this Background of the Disclosure section is only for enhancement of understanding of the general background of the disclosure, and should not be taken as an acknowledgement or any form of suggestion that this information forms the related art already known to a person skilled in the art.

### SUMMARY

Therefore, the present disclosure has been made in view of the above problems, and it is an object of the present disclosure to provide a heating device capable of improving radiant heat transfer efficiency using a heater and a convective heat transfer efficiency through the flow of air and capable of switching between heat supply modes depending on situations.

In accordance with the present disclosure, the above and other objects can be accomplished by the provision of a heating device including a case including an air flow space defined therein, a plurality of thermally conductive plates arranged and rotatably mounted in the air flow space in the case, the plurality of thermally conductive plates including a plurality of ventilation holes formed therein, a heater coupled to each of the plurality of thermally conductive plates, the heater being configured to perform heat-generating operation, a link unit connected to rotation center points of the plurality of thermally conductive plates, and a driving unit connected to the link unit, the driving unit being configured to move the link unit to change a rotational angle of the plurality of thermally conductive plates.

When the plurality of thermally conductive plates is disposed so as to face the air flow direction in the air flow space, the plurality of thermally conductive plates may partially overlap each other in the air flow direction.

The rotation center points of the plurality of thermally conductive plates may be located on the same line, and each of the plurality of thermally conductive plates may include one side portion and the other side portion formed opposite each other with respect to a rotation center point and extending in a straight line. When the plurality of thermally conductive plates is disposed so as to face the air flow direction in the air flow space, one side portion of each of the plurality of thermally conductive plates and the other side portion of a neighboring thermally conductive plate may overlap each other.

When the plurality of thermally conductive plates is disposed so as to face the air flow direction in the air flow space, one side portion of each of the plurality of thermally conductive plates and the other side portion of a neighboring thermally conductive plate may be spaced apart from each other to allow air to flow therebetween.

When the plurality of thermally conductive plates is disposed so as to face the air flow direction in the air flow space, the plurality of ventilation holes in different thermally conductive plates may be misaligned from each other, and when the plurality of thermally conductive plates is disposed so as to be elongated in the air flow direction in the air flow space, the heater coupled to each of the plurality of thermally conductive plates may face a neighboring thermally conductive plate.

When the plurality of thermally conductive plates is disposed so as to face the air flow direction in the air flow space, the heater may be provided on a surface of each of the plurality of thermally conductive plates opposite the air flow direction.

The rotation center points of the plurality of thermally conductive plates may be located on the same line, each of the plurality of thermally conductive plates may include a first panel portion and a second panel portion formed opposite each other with respect to a rotation center point, and the first panel portion and the second panel portion may be formed to be spaced apart from each other and may include the plurality of ventilation holes formed therein.

When the plurality of thermally conductive plates is disposed so as to face the air flow direction in the air flow space, the first panel portion of each of the plurality of thermally conductive plates and the second panel portion of a neighboring thermally conductive plate may face each other in the air flow direction.

When the plurality of thermally conductive plates is disposed so as to face the air flow direction in the air flow space, the first panel portion of each of the plurality of thermally conductive plates and the second panel portion of a neighboring thermally conductive plate may be partially spaced apart from each other in the air flow direction.

Each of the plurality of thermally conductive plates may include a connecting end portion interconnecting the first panel portion and the second panel portion, and the connecting end portion may be connected between the first panel portion and the second panel portion so as to be perpendicular thereto.

The plurality of ventilation holes may be formed in the connecting end portion.

When the plurality of thermally conductive plates is disposed so as to face the air flow direction in the air flow space, the plurality of ventilation holes in different thermally conductive plates may be misaligned from each other, and when the plurality of thermally conductive plates is disposed so as to be elongated in the air flow direction in the air flow space, the heater coupled to each of the plurality of thermally conductive plates may face a neighboring thermally conductive plate.

When the plurality of thermally conductive plates is disposed so as to face the air flow direction in the air flow space, the heater may be provided on a surface of each of the plurality of thermally conductive plates opposite the air flow direction.

Each of the plurality of thermally conductive plates may include a fixed portion disposed so as to be elongated in the air flow direction in the air flow space and a rotating portion rotatably connected to the fixed portion, and the plurality of ventilation holes may be formed in the fixed portion and the rotating portion.

Each of the plurality of thermally conductive plates may be mounted in the case such that a connecting point between the fixed portion and the rotating portion is defined as a rotation center point, and the air flow direction may be changed depending on change in the rotational angle of the rotating portion.

The plurality of thermally conductive plates may be disposed such that the fixed portion of each of the plurality of thermally conductive plates and the heater coupled to the fixed portion of a neighboring thermally conductive plate face each other.

The plurality of thermally conductive plates may be adjusted in rotational position depending on modes. In a radiation mode, the plurality of thermally conductive plates may be disposed so as to face the air flow direction in the air flow space. In a convection mode, the plurality of thermally conductive plates may be disposed so as to be elongated in the air flow direction in the air flow space.

### BRIEF DESCRIPTION OF THE FIGURES

The above and other objects, features, and other advantages of the present disclosure will be more clearly understood from the following detailed description taken in conjunction with the accompanying drawings, in which:

FIG. 1 is a view showing a case of a heating device according to the present disclosure;

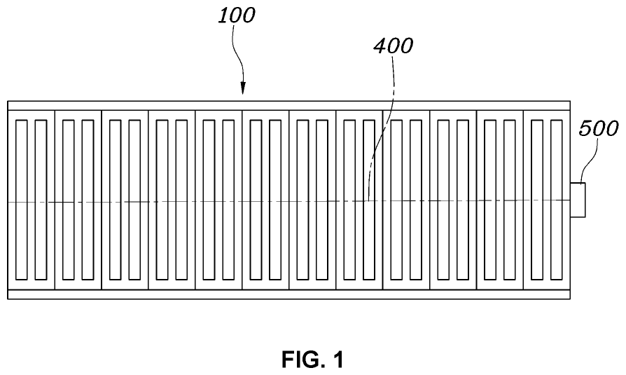

FIG. 2 is a view showing a radiation mode in a heating device according to an embodiment of the present disclosure;

FIG. 3 is a view showing a convection mode in the heating device according to the embodiment of the present disclosure;

FIG. 4 is a view showing a radiation mode in a heating device according to another embodiment of the present disclosure;

FIG. 5 is a view showing a convection mode in the heating device according to the other embodiment of the present disclosure;

FIG. 6 is a view showing a radiation mode in a heating device according to still another embodiment of the present disclosure; and

FIG. 7 is a view showing a convection mode in the heating device according to the still other embodiment of the present disclosure.

### DETAILED DESCRIPTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

It will be further understood that the terms “comprises”, “comprising”, “includes”, and/or “including”, when used herein, specify the presence of stated features, integers, steps, operations, elements, components, or combinations thereof, but do not preclude the presence or addition of one or more other features, integers, steps, operations, elements, components, or combinations thereof.

In order to control the function peculiar thereto, a controller may include a communication device, which communicates with other controllers or sensors, a memory, which stores therein an operating system, logic commands, and input/output information, and one or more processors, which perform determinations, calculations, and decisions necessary for control of the function peculiar thereto.

Hereinafter, a heating device according to an exemplary embodiment of the present disclosure will be described with reference to the accompanying drawings.

The heating device according to the present disclosure may be applied to an air-conditioning system for mobility vehicles, and may also be applied to various other systems for providing heat for heating.

The heating device according to the present disclosure may be implemented as various embodiments.

The heating device includes a case 100 having an air flow space S defined therein. The case 100 is formed in various shapes depending on the purpose of use, and includes an inlet and an outlet to allow air to flow therethrough.

Air flows through the air flow space S in the case 100, and a thermally conductive plate 200 and a heater 300 are provided in the air flow space S.

The thermally conductive plate 200 is provided in plural. The plurality of thermally conductive plates 200 is arranged and rotatably mounted in the air flow space S in the case 100, and a plurality of ventilation holes H is formed in the plurality of thermally conductive plates 200.

The heater 300 is provided in plural. The plurality of heaters 300 is coupled to the thermally conductive plates 200 and performs heat-generating operation. The heaters 300 may be film heaters capable of being attached to the thermally conductive plates 200.

The thermally conductive plates 200 may be made of aluminum, and the heaters 300 may be implemented as PTC heaters.

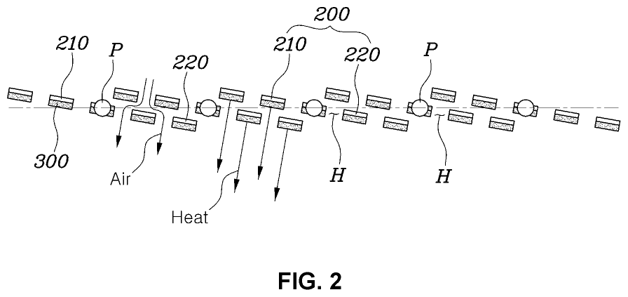

According to an embodiment of the present disclosure, as shown in FIG. 2, the thermally conductive plates 200 may be arranged across the air flow space S in the case 100, and may be rotatably mounted to change the flow direction of the air flowing through the air flow space S. For example, the thermally conductive plates 200 may be disposed so as to face the air flow direction in the air flow space S, or may be disposed so as to be elongated in the air flow direction in the air flow space S. Accordingly, the thermally conductive plates 200 may adjust the flow direction of the air flowing through the air flow space S.

Since the plurality of ventilation holes H is formed in the thermally conductive plates 200, air may flow through the ventilation holes H even when the thermally conductive plates 200 are disposed so as to face the air flow direction in the air flow space S.

Since the heaters 300 are coupled to the thermally conductive plates 200, the heaters 300 may be changed in position together with the thermally conductive plates 200. The heaters 300 function to heat air flowing through the air flow space S and to provide heat to the thermally conductive plates 200 through heat-generating operation thereof, thereby improving convective heat transfer performance.

In order to rotate the thermally conductive plates 200, the heating device according to the present disclosure further includes a link unit 400 connected to rotation center points P of the thermally conductive plates 200 and a driving unit 500 connected to the link unit 400 to move the link unit 400 and thus to rotate the thermally conductive plates 200.

The link unit 400 may be configured to be connected to the rotation center points of the thermally conductive plates 200 and to convert linear movement thereof by the driving unit 500 into rotational movement of the thermally conductive plates 200. For example, the driving unit 500 may be implemented as a motor, and the link unit 400 may be connected to the thermally conductive plates 200 through a rack-and-pinion mechanism. Accordingly, the thermally conductive plates 200 may be rotated simultaneously with operation of the driving unit 500. The driving unit 500 may be controlled by a controller.

The driving unit 500 may be mounted outside the case 100 so as not to interfere with the flow of air, and the link unit 400 passes through the case 100 so as to be connected to the thermally conductive plates 200.

According to the embodiment of the present disclosure, when the thermally conductive plates 200 are disposed so as to face the air flow direction in the air flow space S, the thermally conductive plates 200 may partially overlap each other in the air flow direction.

As such, when the thermally conductive plates 200 are changed in rotational position so as to face the air flow direction in the air flow space S, the thermally conductive plates 200 partially overlap each other, thereby improving radiant heat efficiency through the heaters 300.

In detail, the rotation center points of the thermally conductive plates 200 are located on the same line. Each of the thermally conductive plates 200 includes one side portion 210 and the other side portion 220, which are formed opposite each other with respect to the rotation center point and extend in a straight line. When the thermally conductive plates 200 are disposed so as to face the air flow direction in the air flow space S, one side portion 210 of each of the thermally conductive plates 200 and the other side portion 220 of a neighboring thermally conductive plate 200 may overlap each other.

As such, since the rotation center points of the thermally conductive plates 200 are located on the same line, it is easy to form a structure in which the thermally conductive plates 200 are connected to each other via the link unit 400 and rotated simultaneously. In addition, since the rotation center points of the thermally conductive plates 200 are located on the same line, when the thermally conductive plates 200 are rotated so as to face the air flow direction in the air flow space S, one side portion 210 of each of the thermally conductive plates 200 and the other side portion 220 of a neighboring thermally conductive plate 200 may overlap each other in an oblique direction. One side portion 210 and the other side portion 220 of each of the thermally conductive plates 200 may be formed to have the same length.

When the thermally conductive plates 200 are disposed so as to face the air flow direction in the air flow space S, one side portion 210 of each of the thermally conductive plates 200 and the other side portion 220 of a neighboring thermally conductive plate 200 may be spaced apart from each other so that air flows therebetween.

In addition, when the thermally conductive plates 200 are disposed so as to face the air flow direction in the air flow space S, the ventilation holes H formed in different thermally conductive plates 200 may be misaligned from each other. When the thermally conductive plates 200 are disposed so as to be elongated in the air flow direction in the air flow space S, the heater 300 coupled to each of the thermally conductive plates 200 may face a neighboring thermally conductive plate 200.

In other words, as can be seen in FIG. 2, since the thermally conductive plates 200 are simultaneously rotated at the same angle, when the thermally conductive plates 200 are disposed so as to face the air flow direction in the air flow space S, the thermally conductive plates 200 are oriented in the same oblique direction, and one side portion 210 of each of the thermally conductive plates 200 and the other side portion 220 of a neighboring thermally conductive plate 200 face each other. In this case, since the thermally conductive plates 200 are disposed so as to be oriented in the oblique direction, one side portion 210 of each of the thermally conductive plates 200 and the other side portion 220 of a neighboring thermally conductive plate 200 are spaced apart from each other, and thus air flows therebetween. Accordingly, the air flowing through the air flow space S in the case 100 passes through the ventilation holes H in the thermally conductive plates 200 and spreads between one side portion 210 of each of the thermally conductive plates 200 and the other side portion 220 of a neighboring thermally conductive plate 200, whereby a heating area through the heaters 300 may be increased.

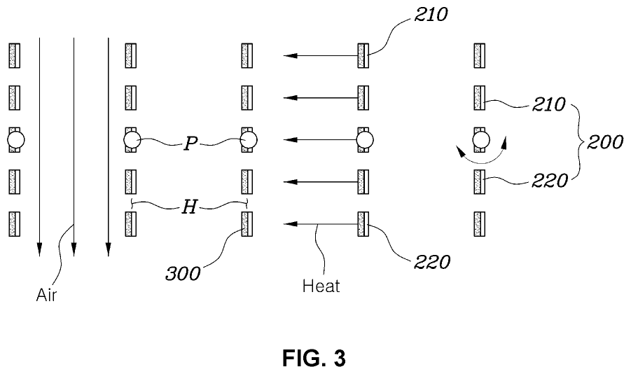

In addition, as can be seen in FIG. 3, when the thermally conductive plates 200 are disposed so as to be elongated in the air flow direction in the air flow space S, the heater 300 coupled to each of the thermally conductive plates 200 may provide heat to a neighboring thermally conductive plate 200. As a result, the thermally conductive plates 200 may dissipate radiant heat, and thus convective heat transfer performance may be improved.

Meanwhile, in the state in which the thermally conductive plates 200 are disposed so as to face the air flow direction in the air flow space S, the heaters 300 may be provided on the surfaces of the thermally conductive plates 200 opposite the air flow direction. Accordingly, radiant heat transfer performance is secured as the heaters 300 generate heat in a direction in which heat should be provided in the air flow space S in the case 100.

As described above, according to the embodiment of the present disclosure, the rotational position of the thermally conductive plates 200 is determined depending on modes. That is, in the radiation mode, the thermally conductive plates 200 may be disposed so as to face the air flow direction in the air flow space S, and in the convection mode, the thermally conductive plates 200 may be disposed so as to be elongated in the air flow direction in the air flow space S.

The radiation mode is a mode for improvement of radiant heat transfer performance. As shown in FIG. 2, since the thermally conductive plates 200 are disposed so as to face the air flow direction in the air flow space S, the thermally conductive plates 200 partially overlap each other in an oblique direction. Accordingly, the heaters 300 coupled to the thermally conductive plates 200 are oriented in the air flow direction, thereby improving radiant heat transfer efficiency. Further, air is heated by the heaters 300 while flowing between the thermally conductive plates 200.

The convection mode is a mode for improvement of convective heat transfer performance. As shown in FIG. 3, since the thermally conductive plates 200 are disposed so as to be elongated in the air flow direction in the air flow space S, resistance to the flow of air passing through the air flow space S is reduced. In particular, since the thermally conductive plates 200 are disposed so as to face each other, heat generated from the heater 300 coupled to each of the thermally conductive plates 200 is transferred to a neighboring thermally conductive plate 200. As a result, the amount of energy wasted as radiant heat is reduced, thus making it easy to increase the temperature of convective heat.

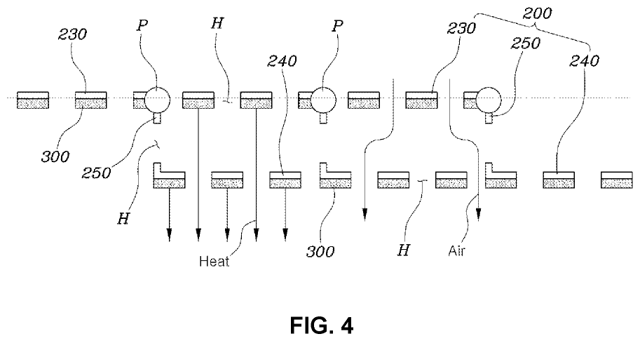

According to another embodiment, as shown in FIG. 4, the rotation center points of the thermally conductive plates 200 are located on the same line, and each of the thermally conductive plates 200 includes a first panel portion 230 and a second panel portion 240, which are formed opposite each other with respect to the rotation center point. The first panel portion 230 and the second panel portion 240 may be formed to be spaced apart from each other, and may include a plurality of ventilation holes H formed therein.

Accordingly, when the thermally conductive plates 200 are disposed so as to face the air flow direction in the air flow space S, the first panel portion 230 of each of the thermally conductive plates 200 and the second panel portion 240 of a neighboring thermally conductive plate 200 may partially face each other in the air flow direction.

The thermally conductive plates 200 may be arranged across the air flow space S in the case 100, and may be rotatably mounted therein. The first panel portion 230 and the second panel portion 240 of each of the thermally conductive plates 200 may be formed to be spaced apart from each other, and the ventilation holes H may be formed in each of the panel portions. Thus, the thermally conductive plates 200 may change the flow direction of the air flowing through the air flow space S depending on the rotational position thereof.

For example, the thermally conductive plates 200 may be disposed so as to face the air flow direction in the air flow space S, or may be disposed so as to be elongated in the air flow direction in the air flow space S. Accordingly, the thermally conductive plates 200 may adjust the flow direction of the air flowing through the air flow space S.

In detail, the rotation center points of the thermally conductive plates 200 are located on the same line, and when the thermally conductive plates 200 are disposed so as to face the air flow direction in the air flow space S, the first panel portion 230 of each of the thermally conductive plates 200 and the second panel portion 240 of a neighboring thermally conductive plate 200 may be disposed so as to be spaced apart from each other in the air flow direction.

As can be seen in FIG. 4, since the rotation center points of the thermally conductive plates 200 are located on the same line, it is possible to form a structure in which the thermally conductive plates 200 are connected to each other via the link unit 400 and rotated simultaneously.

In addition, since the first panel portion 230 and the second panel portion 240 of each of the thermally conductive plates 200 are formed to be spaced apart from each other, when the thermally conductive plates 200 are disposed so as to face the air flow direction, the first panel portion 230 of each of the thermally conductive plates 200 and the second panel portion 240 of a neighboring thermally conductive plate 200 may overlap each other in the air flow direction in the air flow space S.

Each of the thermally conductive plates 200 may include a connecting end portion 250 interconnecting the first panel portion 230 and the second panel portion 240, and the connecting end portion 250 may be connected between the first panel portion 230 and the second panel portion 240 so as to be perpendicular thereto.

In this way, each of the thermally conductive plates 200 may include the first panel portion 230, the connecting end portion 250, and the second panel portion 240, and the first panel portion 230 and the second panel portion 240 may extend from respective ends of the connecting end portion 250 in opposite directions so as to be perpendicular to the connecting end portion 250. The first panel portion 230 and the second panel portion 240 of each of the thermally conductive plates 200 may be formed to have the same length.

Accordingly, when the thermally conductive plates 200 are disposed so as to face the air flow direction in the air flow space S, the first panel portion 230 of each of the thermally conductive plates 200 and the second panel portion 240 of a neighboring thermally conductive plate 200 may be disposed so as to be spaced apart from each other in the air flow direction, and thus air may flow between the first panel portion 230 and the second panel portion 240.

In addition, the ventilation holes H may also be formed in the connecting end portions 250 of the thermally conductive plates 200. Accordingly, when the thermally conductive plates 200 are disposed so as to be elongated in the air flow direction in the air flow space S, the first panel portions 230 and the second panel portions 240 are disposed so as to be elongated in the air flow direction, and thus resistance to the flow of air is reduced. In addition, since air passes through the ventilation holes H in the connecting end portions 250, air flow loss due to the connecting end portions 250 is reduced.

On the other hand, when the thermally conductive plates 200 are disposed so as to face the air flow direction in the air flow space S, the ventilation holes H formed in different thermally conductive plates 200 may be misaligned from each other. When the thermally conductive plates 200 are disposed so as to be elongated in the air flow direction in the air flow space S, the heater 300 coupled to each of the thermally conductive plates 200 may face a neighboring thermally conductive plate 200.

As can be seen in FIG. 4, since the thermally conductive plates 200 are simultaneously rotated at the same angle, when the thermally conductive plates 200 are disposed so as to face the air flow direction in the air flow space S, the first panel portions 230 and the second panel portions 240 are disposed across the air flow space S, and the first panel portion 230 of each of the thermally conductive plates 200 and the second panel portion 240 of a neighboring thermally conductive plate 200 face each other in a state of being spaced apart from each other.

In addition, since the first panel portion 230 of each of the thermally conductive plates 200 and the second panel portion 240 of a neighboring thermally conductive plate 200 are spaced apart from each other, air may flow therebetween. Accordingly, the air flowing through the air flow space S in the case 100 passes through the ventilation holes H in the thermally conductive plates 200 and spreads between the first panel portion 230 of each of the thermally conductive plates 200 and the second panel portion 240 of a neighboring thermally conductive plate 200, whereby a heating area through the heaters 300 may be increased.

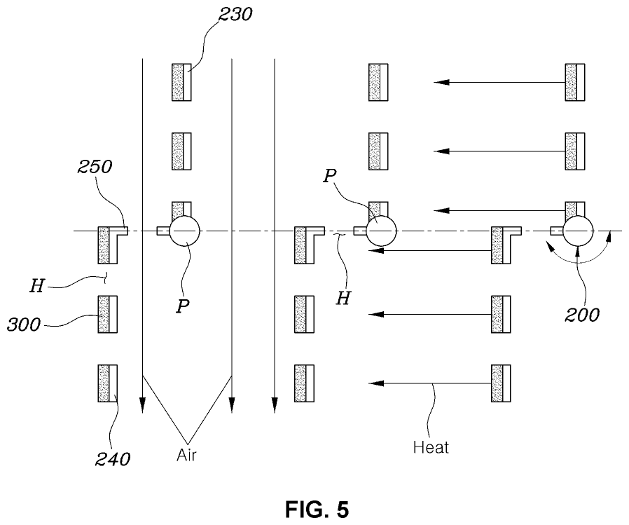

In addition, as shown in FIG. 5, when the thermally conductive plates 200 are disposed so as to be elongated in the air flow direction in the air flow space S, air flows through the ventilation holes H formed in the connecting end portions 250 of the thermally conductive plates 200, the first panel portions 230 of the thermally conductive plates 200 face each other, and the second panel portions 240 of the thermally conductive plates 200 face each other. In this state, the heater 300 coupled to each of the thermally conductive plates 200 provides heat to the panel portions of a neighboring thermally conductive plate 200. As a result, the thermally conductive plates 200 may dissipate radiant heat, and thus convective heat transfer performance may be improved.

Meanwhile, in the state in which the thermally conductive plates 200 are disposed so as to face the air flow direction in the air flow space S, the heaters 300 may be provided on the surfaces of the thermally conductive plates 200 opposite the air flow direction. Accordingly, radiant heat transfer performance is secured as the heaters 300 generate heat in a direction in which heat should be provided in the air flow space S in the case 100.

As described above, according to the other embodiment of the present disclosure, the rotational position of the thermally conductive plates 200 is determined depending on modes. That is, in the radiation mode, the thermally conductive plates 200 may be disposed so as to face the air flow direction in the air flow space S, and in the convection mode, the thermally conductive plates 200 may be disposed so as to be elongated in the air flow direction in the air flow space S.

The radiation mode is a mode for improvement of radiant heat transfer performance. As shown in FIG. 4, since the thermally conductive plates 200 are disposed so as to face the air flow direction in the air flow space S, the first panel portion 230 of each of the thermally conductive plates 200 and the second panel portion 240 of a neighboring thermally conductive plate 200 overlap each other in the air flow direction. Accordingly, the heaters 300 coupled to the thermally conductive plates 200 are oriented in the air flow direction, thereby improving radiant heat transfer efficiency. Further, air is heated by the heaters 300 while flowing between the thermally conductive plates 200.

The convection mode is a mode for improvement of convective heat transfer performance. As shown in FIG. 5, since the thermally conductive plates 200 are disposed such that the first panel portions 230 and the second panel portions 240 are elongated in the air flow direction in the air flow space S, resistance to the flow of air passing through the air flow space S is reduced. In particular, since the thermally conductive plates 200 are disposed so as to face each other, heat generated from the heater 300 coupled to each of the thermally conductive plates 200 is transferred to a neighboring thermally conductive plate 200. As a result, the amount of energy wasted as radiant heat is reduced, thus making it easy to increase the temperature of convective heat.

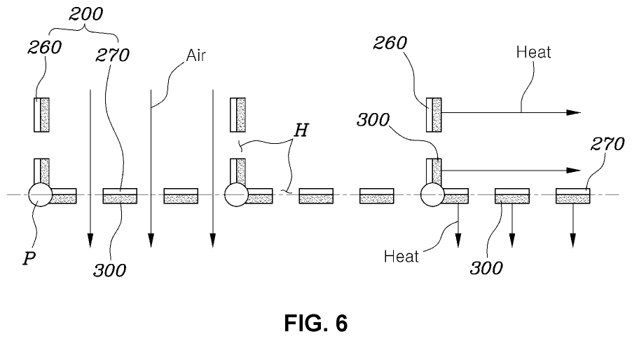

According to still another embodiment, as shown in FIG. 6, each of the thermally conductive plates 200 includes a fixed portion 260, which is disposed so as to be elongated in the air flow direction in the air flow space, a rotating portion 270, which is rotatably connected to the fixed portion 260, and a plurality of ventilation holes H formed in the fixed portion 260 and the rotating portion 270.

In detail, the thermally conductive plates 200 may be arranged across the air flow space S in the case 100, and each of the thermally conductive plates 200 is composed of the fixed portion 260 and the rotating portion 270. Here, the fixed portion 260 is disposed so as to be elongated in the air flow direction in the air flow space S in the case 100, and the rotating portion 270 is rotatably mounted to the fixed portion 260. The rotating portion 270 may be located closer to the outlet of the air flow space S than the fixed portion 260.

The ventilation holes H may be formed in the fixed portions 260 and the rotating portions 270 of the thermally conductive plates 200, and the thermally conductive plates 200 may adjust the flow direction of the air flowing through the air flow space S depending on the rotational position of the rotating portions 270.

For example, the rotating portions 270 of the thermally conductive plates 200 may be disposed so as to face the air flow direction in the air flow space S, or may be disposed so as to be elongated in the air flow direction in the air flow space S. Accordingly, the thermally conductive plates 200 may adjust the flow direction of the air flowing through the air flow space S.

In detail, each of the thermally conductive plates 200 may be mounted in the case 100 such that the fixed portion 260 and the rotating portion 270 are connected to each other and a connecting point between the fixed portion 260 and the rotating portion 270 is defined as a rotation center point.

As can be seen in FIG. 6, in each of the thermally conductive plates 200, the rotating portion 270 is rotatably connected to the fixed portion 260. Since the fixed portion 260 is disposed so as to be elongated in the air flow direction in the air flow space S in the case 100 and the rotating portion 270 is rotated with respect to the fixed portion 260, the fixed portion 260 and the rotating portion 270 of each of the thermally conductive plates 200 may be disposed in an “L” shape or an “I” shape, or may be disposed so as to form an acute angle or an obtuse angle therebetween.

Here, the rotation center points of the thermally conductive plates 200 are located on the same line, thus making it easy to form a structure in which the rotating portions 270 of the thermally conductive plates 200 are rotated simultaneously.

In this way, the fixed portions 260 of the thermally conductive plates 200 are arranged across the air flow space S so as to face each other. That is, the heater 300 coupled to each of the thermally conductive plates 200 faces the fixed portion 260 of a neighboring thermally conductive plate 200 and provides heat to the fixed portion 260. As a result, the thermally conductive plates 200 may dissipate radiant heat, and thus convective heat transfer performance may be improved.

In addition, in each of the thermally conductive plates 200, the rotating portion 270 is rotated with respect to the fixed portion 260, and accordingly, the air flow direction and the radiant heat emission direction of the heater 300 may be adjusted depending on the rotational position of the rotating portion 270.

As described above, according to the still other embodiment of the present disclosure, the rotational position of the rotating portions 270 of the thermally conductive plates 200 is determined depending on modes. That is, in the radiation mode, the rotating portions 270 of the thermally conductive plates 200 may be disposed so as to face the air flow direction in the air flow space S, and in the convection mode, the rotating portions 270 of the thermally conductive plates 200 may be disposed so as to be elongated in the air flow direction in the air flow space S.

The radiation mode is a mode for improvement of radiant heat transfer performance. As shown in FIG. 6, the rotating portions 270 of the thermally conductive plates 200 are disposed so as to face the air flow direction in the air flow space S. Accordingly, the heaters 300 coupled to the rotating portions 270 of the thermally conductive plates 200 are oriented in the air flow direction, thereby improving radiant heat transfer efficiency. Further, air is heated by the heaters 300 provided on the fixing portions 260 and the rotating portions 270, and flows through the ventilation holes H in the rotating portions 270.

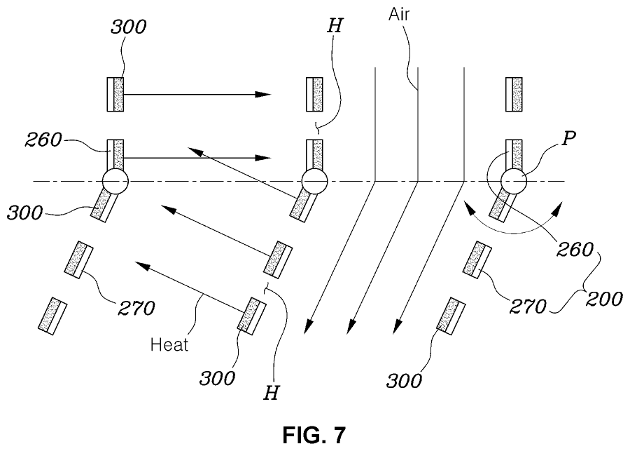

The convection mode is a mode for improvement of convective heat transfer performance. As shown in FIG. 7, since the rotating portions 270 of the thermally conductive plates 200 are disposed so as to be elongated in the air flow direction in the air flow space S, resistance to the flow of air passing through the air flow space S is reduced. In addition, since the fixed portions 260 of the thermally conductive plates 200 are disposed so as to face each other, heat generated from the heater 300 coupled to the fixing portion 260 of each of the thermally conductive plates 200 is transferred to the fixing portion 260 of a neighboring thermally conductive plate 200. As a result, the amount of energy wasted as radiant heat is reduced, thus making it easy to increase the temperature of convective heat. In addition, the air flow direction may be changed depending on the rotational angle of the rotating portions 270.

As is apparent from the above description, the heating device structured as described above may provide heat for heating in various modes, such as an air flow direction control mode, a radiant heat specialized mode, and a convective heat specialized mode, through rotation of the thermally conductive plates depending on user's requirements, thereby increasing user satisfaction.

In addition, the thermally conductive plates may increase heating efficiency by ensuring thermal efficiency according to a mode corresponding to the purpose of use.

Although the preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

1. A heating device comprising:
a case comprising an air flow space defined therein;
a plurality of thermally conductive plates arranged and rotatably mounted in the air flow space in the case, the plurality of thermally conductive plates comprising a plurality of ventilation holes;
a heater coupled to each of the plurality of thermally conductive plates, each of the heaters being configured to generate heat;
a link unit connected to rotation center points of each of the plurality of thermally conductive plates; and
a driving unit connected to the link unit, the driving unit being configured to move the link unit to change a rotational angle of each of the plurality of thermally conductive plates.

2. The heating device according to claim 1, wherein, when the plurality of thermally conductive plates faces an air flow direction in the air flow space, the plurality of thermally conductive plates each partially overlaps in the air flow direction.

3. The heating device according to claim 1, wherein the rotation center points of each of the plurality of thermally conductive plates are located on a same line;
wherein each of the plurality of thermally conductive plates comprises one side portion and an other side portion formed opposite to the one side portion with respect to a rotation center point and extending in a straight line; and
wherein, when each of the plurality of thermally conductive plates faces an air flow direction in the air flow space, the one side portion of each of the plurality of thermally conductive plates and an other side portion of a neighboring thermally conductive plate overlap.

4. The heating device according to claim 3, wherein, when each of the plurality of thermally conductive plates faces the air flow direction in the air flow space, the one side portion of each of the plurality of thermally conductive plates and the other side portion of the neighboring thermally conductive plate are spaced apart from each other to allow air to flow therebetween.

5. The heating device according to claim 1, wherein, when each of the plurality of thermally conductive plates faces an air flow direction in the air flow space, the plurality of ventilation holes in different thermally conductive plates is misaligned from each other, and
wherein, when each of the plurality of thermally conductive plates is elongated in the air flow direction in the air flow space, the heater coupled to each of the plurality of thermally conductive plates faces a neighboring thermally conductive plate.

6. The heating device according to claim 5, wherein, when each of the plurality of thermally conductive plates faces the air flow direction in the air flow space, the heater is provided on a surface of each of the plurality of thermally conductive plates opposite the air flow direction.

7. The heating device according to claim 1, wherein the rotation center points of the plurality of thermally conductive plates are located on the same line;
wherein each of the plurality of thermally conductive plates comprises a first panel portion and a second panel portion formed opposite each other with respect to a rotation center point; and
wherein the first panel portion and the second panel portion are spaced apart from each other and comprise the plurality of ventilation holes.

8. The heating device according to claim 7, wherein, when each of the plurality of thermally conductive plates faces an air flow direction in the air flow space, the first panel portion of each of the plurality of thermally conductive plates and the second panel portion of a neighboring thermally conductive plate face each other in the air flow direction.

9. The heating device according to claim 7, wherein, when each of the plurality of thermally conductive plates faces an air flow direction in the air flow space, the first panel portion of each of the plurality of thermally conductive plates and the second panel portion of a neighboring thermally conductive plate are partially spaced apart from each other in the air flow direction.

10. The heating device according to claim 7, wherein each of the plurality of thermally conductive plates comprises a connecting end portion interconnecting the first panel portion and the second panel portion, and
wherein the connecting end portion is connected between the first panel portion and the second panel portion so as to be perpendicular thereto.

11. The heating device according to claim 10, wherein the plurality of ventilation holes is formed in the connecting end portion.

12. The heating device according to claim 7, wherein, when each of the plurality of thermally conductive plates faces an air flow direction in the air flow space, the plurality of ventilation holes in different thermally conductive plates is misaligned from each other, and
wherein, when each of the plurality of thermally conductive plates is elongated in the air flow direction in the air flow space, the heater coupled to each of the plurality of thermally conductive plates faces a neighboring thermally conductive plate.

13. The heating device according to claim 7, wherein, when each of the plurality of thermally conductive plates faces an air flow direction in the air flow space, the heater is provided on a surface of each of the plurality of thermally conductive plates opposite the air flow direction.

14. The heating device according to claim 1, wherein each of the plurality of thermally conductive plates comprises a fixed portion elongated in an air flow direction in the air flow space and a rotating portion rotatably connected to the fixed portion, and
wherein the plurality of ventilation holes is formed in the fixed portion and the rotating portion.

15. The heating device according to claim 14, wherein each of the plurality of thermally conductive plates is mounted in the case such that a connecting point between the fixed portion and the rotating portion is defined as a rotation center point, and
wherein the air flow direction is changed depending on change in a rotational angle of the rotating portion.

16. The heating device according to claim 14, wherein each of the plurality of thermally conductive plates is positioned such that the fixed portion of each of the plurality of thermally conductive plates and the heater coupled to the fixed portion of a neighboring thermally conductive plate face each other.

17. The heating device according to claim 1, wherein each of the plurality of thermally conductive plates is adjusted in rotational position depending on modes,
wherein, in a radiation mode, each of the plurality of thermally conductive plates faces an air flow direction in the air flow space, and
wherein, in a convection mode, each of the plurality of thermally conductive plates is elongated in the air flow direction in the air flow space.
